(19) United States
(12) Patent Application Publication
(10) Pub. No.: US 2016/0324333 A1
(43) Pub. Date: Nov. 10, 2016

(54) DISPENSER FOR SIMULTANEOUSLY DISPENSING LIQUID RETAINING MEMBERS FROM A PLURALITY OF DIFFERENT DISPENSING AREAS OF THE DISPENSER

(71) Applicant: Cardomon International Limited, Tsimshatsui (HK)

(72) Inventors: Philip A. Walton, Bishop Auckland (GB); Andrew Smith, Hamsterley (GB)

(21) Appl. No.: 14/705,052

(22) Filed: May 6, 2015

(51) Int. Cl. A47F 1/06; B67D 1/06; A47F 1/08

(52) U.S. Cl. CPC A47F 1/065; A47F 1/085; B67D 1/06

(57) ABSTRACT

A dispenser configured to simultaneously dispenses a plurality of liquid retaining members from a plurality of different areas of the dispenser. Preferably, the liquid retaining members are drinking cups. Preferably, the dispenser is configured to simultaneously dispense a first stack of a plurality of drinking cups and a second stack of a plurality of drinking cups from corresponding ends of the dispensers. The dispenser includes a body having a first end and a second end. The first end has a first opening through which drinking cups in the first stack of a plurality of drinking cups can be individually dispensed one after the other. The second end has a second opening through which drinking cups in the second stack of drinking cups can be individually dispensed one after the other. Preferably, at least one biasing member biases the first stack of a plurality of drinking cups towards the first end of the body and biases the second stack of a plurality of drinking cups towards the second end of the body.

### FIELD OF THE INVENTION

The present invention is directed to a dispensing apparatus for simultaneously dispensing liquid retaining members from a plurality of different portions or areas of the dispensing apparatus.

### BACKGROUND OF THE INVENTION

Previously developed dispensers for dispensing liquid retaining members (e.g., drinking cups) have a number of disadvantages and/or limitations. Cup dispensers have been configured to dispense a stack of drinking cups using gravity. However, such gravity type cup dispensers require individual drinking cups from a stack of drinking cups housed in the cup dispenser to be dispensed from the bottom of the cup dispenser. Cup dispensers have also utilized a spring element to bias the drinking cups toward an upper end of the cup dispenser so that drinking cups can be dispensed from the top of the cup dispenser. However, there exists a need for a cup dispenser that can simultaneously dispenses cups for a plurality of different dispensing areas or portions of the cup dispenser. Further, there is a need for a cup dispenser that can simultaneously dispense different size drinking cups from a cup dispenser. Moreover, there is a need for a cup dispenser that is readily adjustable, simple to manufacture and simple to use and/or mount in an operating position.

### OBJECTS AND SUMMARY OF THE INVENTION

An object of a preferred embodiment of the present invention is to provide a novel and unobvious apparatus for dispensing liquid retaining members.

Another object of a preferred embodiment of the present invention is to provide a novel and unobvious apparatus for dispensing liquid retaining members configured to be mounted on or adjacent a liquid dispensing apparatus.

A further object of a preferred embodiment of the present invention is to provide a cup dispenser for simultaneously dispensing cups from multiple different portions of the cup dispenser.

Still another object of a preferred embodiment of the present invention is to provide a cup dispenser for simultaneously dispensing cups from multiple different portions of the cup dispenser that can be readily mounted on or adjacent a liquid dispensing apparatus.

A further object of a preferred embodiment of the present invention is to provide a cup dispenser for simultaneously dispensing cups from multiple different portions of the cup dispenser having a single biasing means for biasing different stacks of cups towards different dispensing areas or portions of the cup dispenser.

Yet another object of a preferred embodiment of the present invention is to provide a double ended cup dispenser for simultaneously dispensing cups from opposing ends of the double ended cup dispenser.

Still a further object of a preferred embodiment of the present invention is to provide a double ended cup dispenser for simultaneously dispensing different size cups from opposing ends of the double ended cup dispenser.

Yet still another object of a preferred embodiment of the present invention is to provide different size flexible cup retaining and release members that can be positioned adjacent multiple different dispensing locations of a cup dispenser.

Still another object of a preferred embodiment of the present invention is to provide a frame member for detachably supporting a plurality of different size flexible cup retaining and release members.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one preferred embodiment of the present invention is directed to a cup dispenser for housing and dispensing a plurality of drinking cups. The cup dispenser includes a first stack of a plurality of drinking cups, a second stack of a plurality of drinking cups and a body simultaneously housing the first stack of a plurality of drinking cups and the second stack of a plurality of drinking cups. The body has a first end and a second end. The first end has a first opening through which drinking cups in the first stack of a plurality of drinking cups can be dispensed one after the other. The second end has a second opening through which drinking cups in the second stack of drinking cups can be dispensed one after the other. The body is configured such that a drinking cup from the first stack of a plurality of drinking cups can be dispensed at the same time a drinking cup in the second stack of a plurality of drinking cups is dispensed.

Another preferred embodiment of the present invention is directed to a double ended cup dispenser for simultaneously dispensing cups at each of two ends of the double ended cup dispenser. The double ended cup dispenser has a housing having first and second ends. The first end of the housing has a first opening through which one or more cups can dispensed. The second end of the housing has a second opening through which one or more cups can be dispensed at substantially the same time cups are dispensed from the first end of the housing. A first cup support member is disposed in the housing for supporting one or more cups. A second cup support member is disposed in the housing for supporting one or more cups. At least one biasing member is configured to bias the first cup support member toward the first end of the housing and bias the second cup support member toward the second end of the housing.

A further preferred embodiment of the present invention is directed to a liquid dispensing apparatus including a liquid dispenser for dispensing one or more liquids and a double ended cup dispenser for simultaneously dispensing cups at each of two ends on the double ended cup dispenser.

### BRIEF DESCRIPTION OF THE DRAWINGS

FIG. 1 is a perspective view of a dispenser for dispensing liquid retaining members formed in accordance with a preferred embodiment of the present invention.

FIG. 2 is a perspective view of the dispenser depicted in FIG. 1 with portions of the housing removed.

FIG. 3 is an elevational view of the dispenser depicted in FIG. 1. FIG. 4 is an elevational view of the dispenser depicted in FIG. 1 with a single stack of large drinking cups positioned to be dispensed from the top of the dispenser.

FIG. 5 is an elevational view of the dispenser depicted in FIG. 1 with a single stack of small drinking cups positioned to be dispensed from the top of the dispenser.

FIG. 6 is a cross-sectional view of the dispenser depicted in FIG. 1 taken along lines 6-6 in FIG. 3.

FIG. 7 is a fragmentary cross-sectional view of a portion of the dispenser depicted in FIG. 1.

FIG. 8 is a fragmentary perspective view of a portion of the dispenser depicted in FIG. 1.

FIG. 9 is a perspective view of a portion of the dispenser depicted in FIG. 1.

FIG. 10 is a fragmentary perspective view of a cup seat formed in accordance with a preferred embodiment of the present invention.

FIG. 11 is a perspective view of a cup seat formed in accordance with a preferred embodiment of the present invention.

FIG. 12 is a fragmentary perspective view of a portion of the dispenser depicted in FIG. 1 with portions thereof removed.

FIG. 13 is a perspective sectional view of a portion of the dispenser depicted in FIG. 1.

FIG. 14 is a perspective sectional view of a portion of one type of releasable cup retainer formed in accordance with a preferred embodiment of the present invention.

FIG. 15 is a perspective view of the releasable cup retainer depicted in FIG. 14.

FIG. 16 is a fragmentary sectional view of the releasable cup retainer depicted in FIG. 14.

FIG. 17 is a cross-sectional view of one end of the dispenser depicted in FIG. 1.

FIG. 18 is a cross-sectional view of the other end of the dispenser depicted in FIG. 1.

FIG. 19 is an elevational view of a dispenser for dispensing liquid retaining members mounted on a liquid dispenser.

### DETAILED DESCRIPTION OF THE PREFERRED EMBODIMENTS OF THE INVENTION

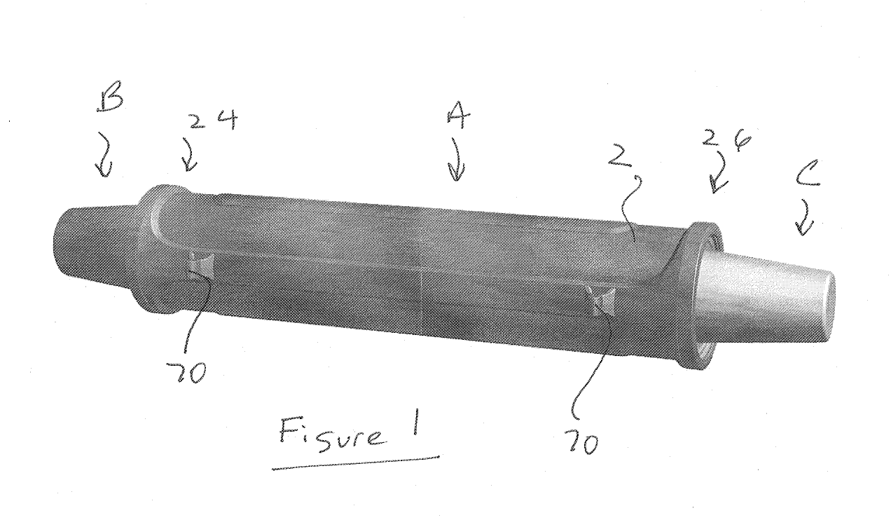

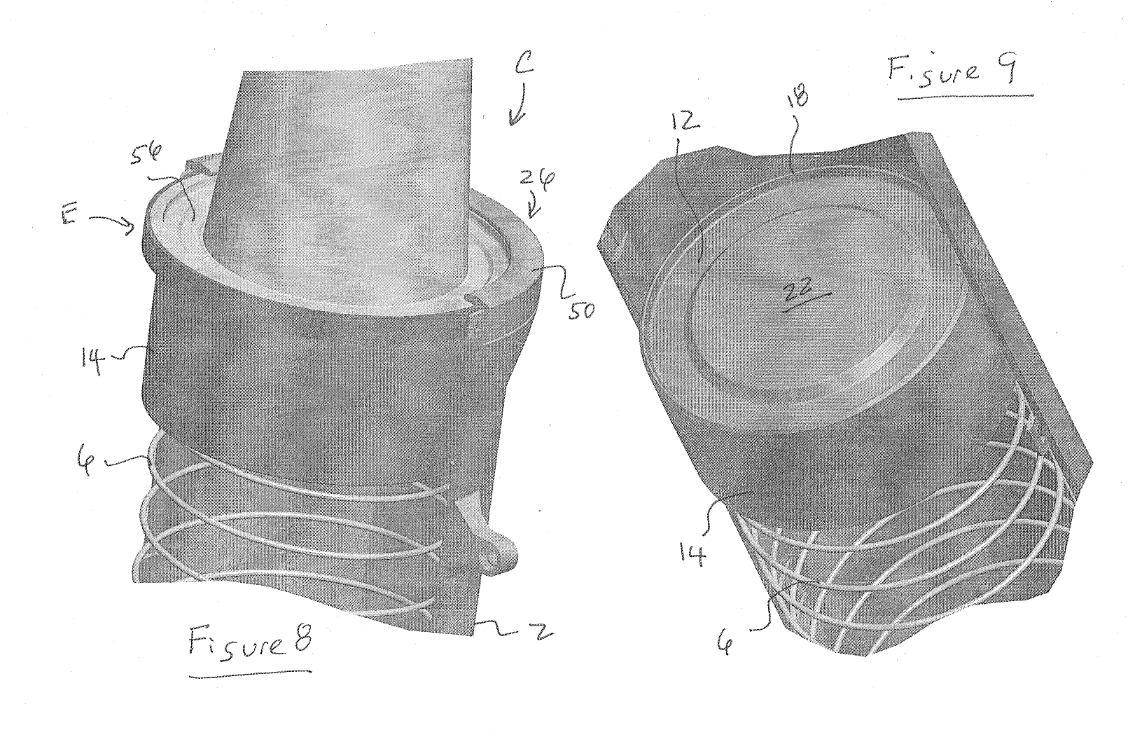

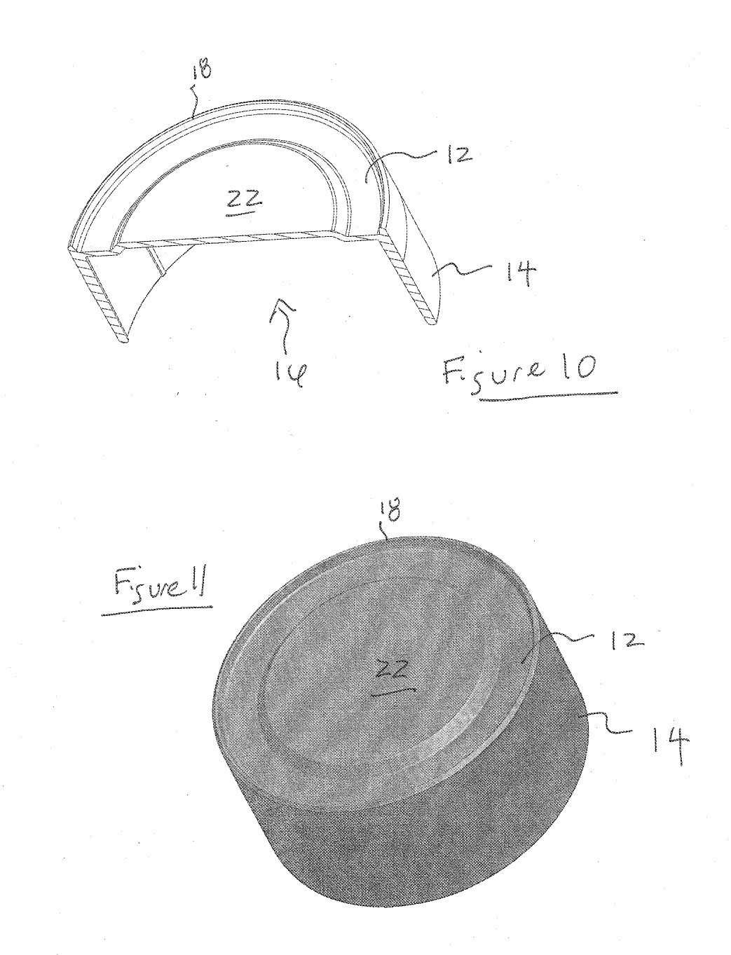

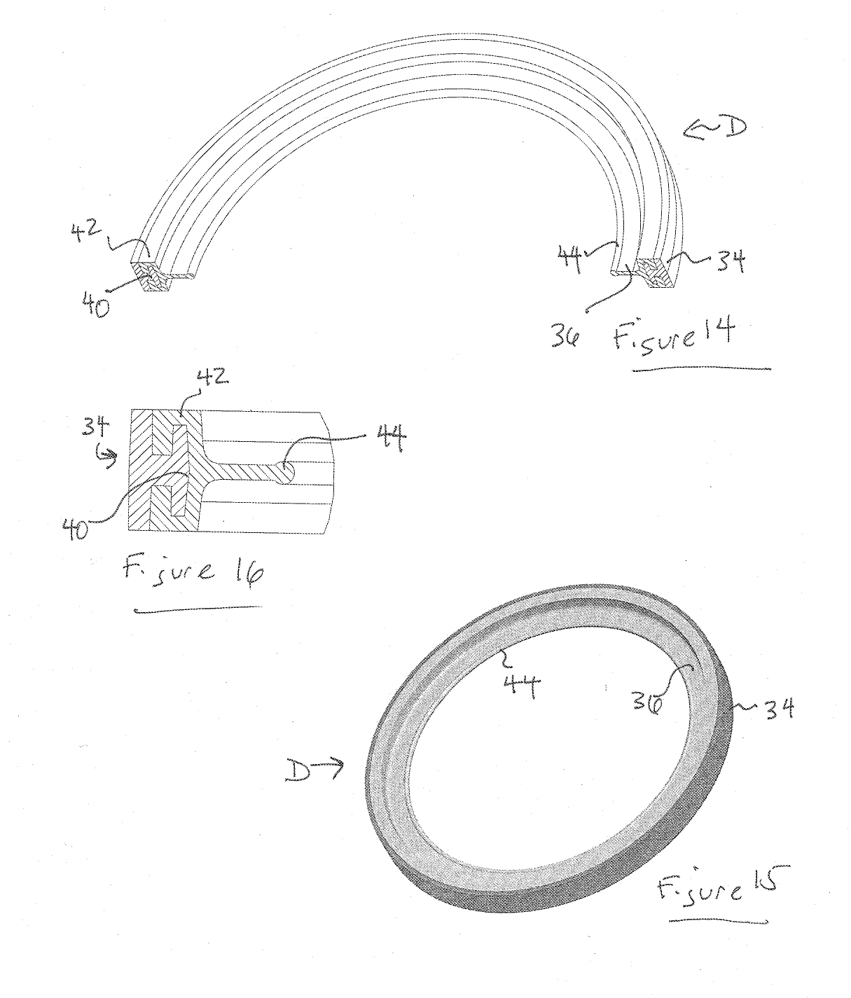

The preferred forms of the invention will now be described with reference to FIGS. 1-19. The appended claims are not limited to the preferred forms and no term and/or phrase used herein is to be given a meaning other than its ordinary meaning unless it is expressly stated otherwise.

### FIGS. 1 THROUGH 19

Referring to FIGS. 1 to 19, a preferred form of dispenser A for simultaneously dispensing a plurality of liquid retaining members from a plurality of different areas or portions of dispenser A is illustrated in one of many possible configurations. In the most preferred form, the liquid retaining members are drinking cups.

Preferably, dispenser A has a substantially tubular housing 2 configured to house and simultaneously dispense a first stack of a plurality of drinking cups B and a second stack of a plurality of drinking cups C. While housing 2 of dispenser A is shown as being a straight substantially tubular housing, it will be readily appreciated that housing 2 could be curved. For example, housing 2 could be U-shaped so that cups from each of the two stacks of drinking cups are positioned adjacent each other.

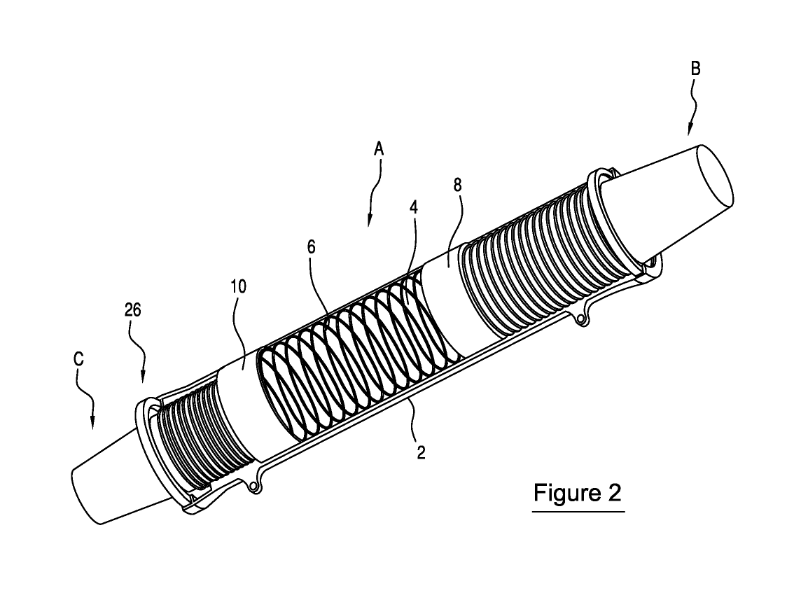

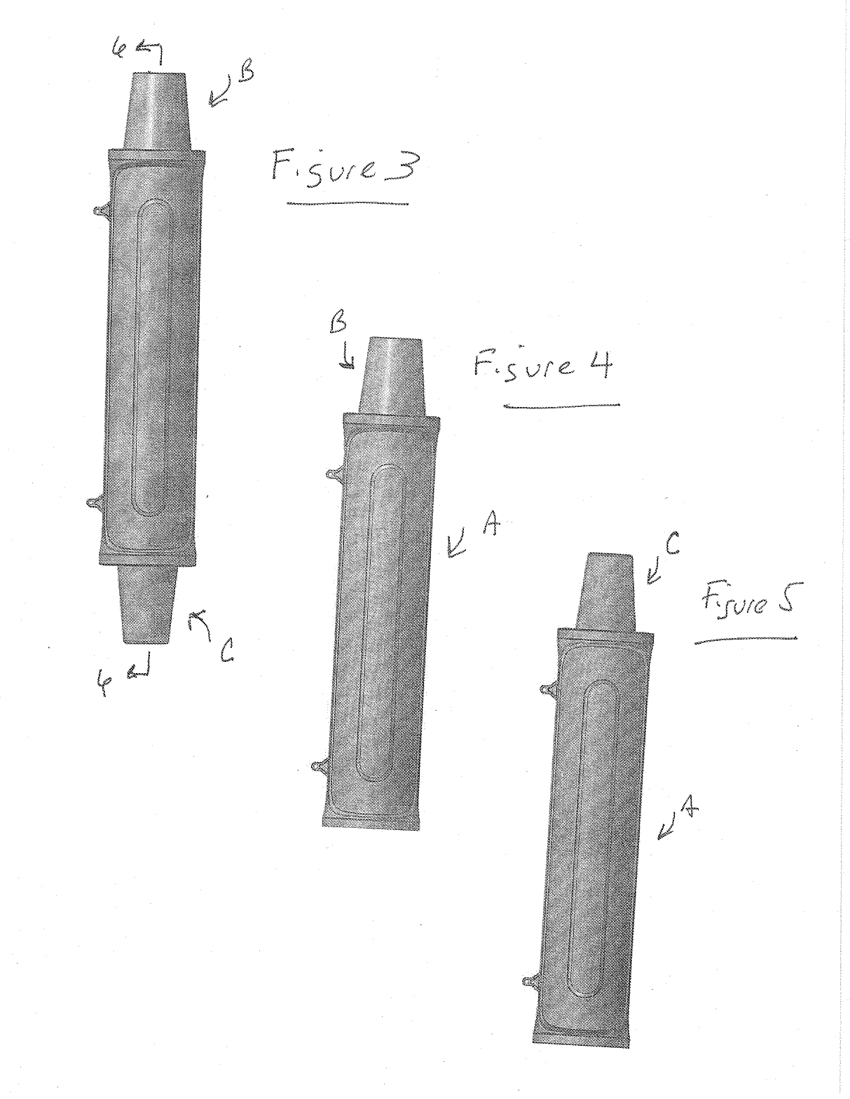

Referring to FIG. 2, housing 2 includes a hollow cavity 4 for receiving a single coil spring 6, a first cup seat 8 and a second cup seat 10. Preferably, first cup seat 8 is identical to second cup seat 10. Referring to FIGS. 8 to 12, first cup seat 8 preferably includes a cup support 12, a skirt 14 and a hollow cavity 16. Cup support 12 is recessed inwardly from top surface 18 of skirt 14. Cup support 12 further has a raised center portion 22. Referring to FIGS. 2, 8 and 9, a first end of coil spring 6 extends into hollow cavity 16 and engages an interior surface of cup support 12 of first cup seat 8. Similarly, a second end of coil spring 6 extends into hollow cavity 16 and engages an interior surface of cup support 12 of second cup seat 10. Coil spring 6 acts to bias first cup seat 8 and the corresponding stack B of drinking cups toward end 24 of housing 2 and bias second cup seat 10 and the corresponding stack of drinking cups C toward end 26 of housing 2. While a single coil spring is preferably used to bias outwardly cup supports 8 and 10, the number and type of baising member used to perform the functions of spring 6 may be varied as desired.

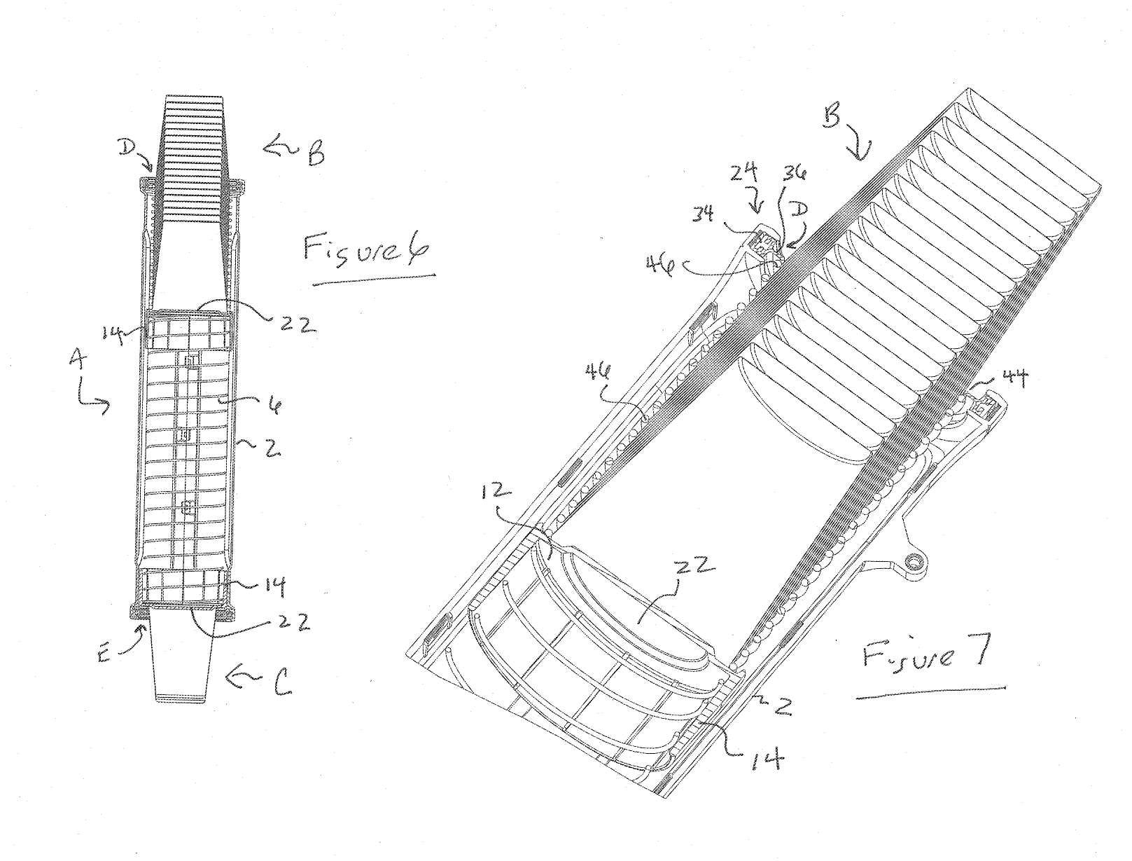

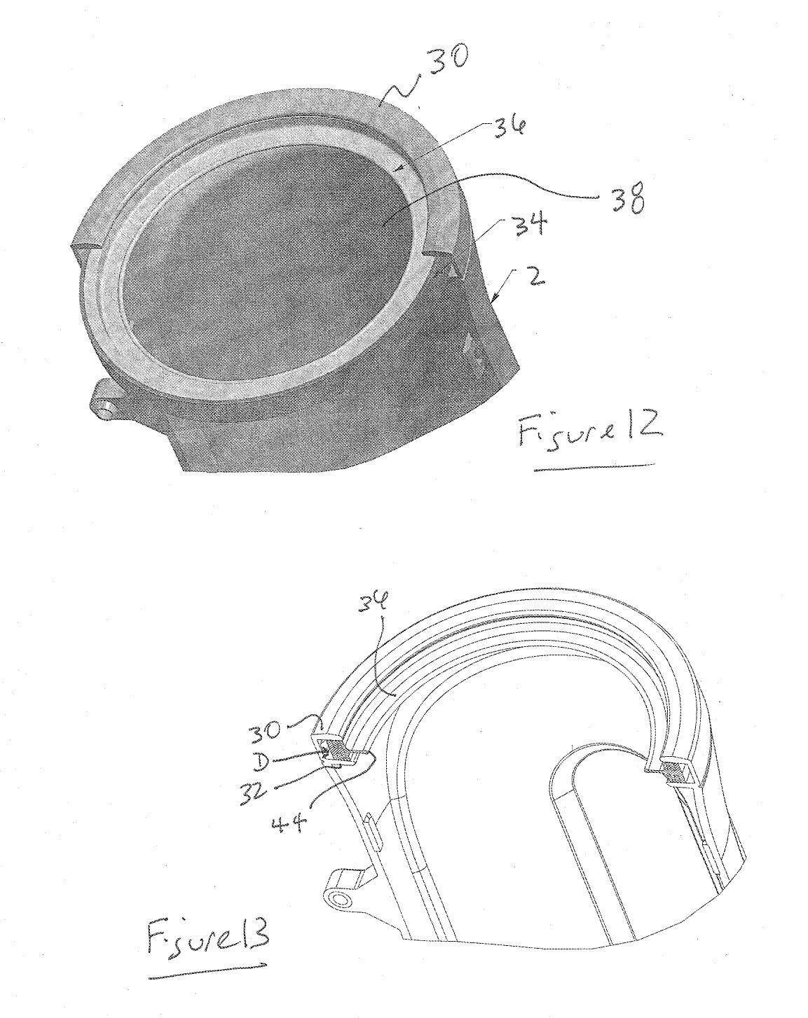

Referring to FIGS. 7, 8 and 12 through 18, the preferred forms of releasable cup retainers D and E will now be described. Preferably, releasable cup retainer D is configured to releasably retain drinking cups of a larger size than releasable cup retainer E. Releasable cup retainer D is seen in, for example, FIGS. 12 through 17 and releasable cup retainer E is seen in, for example, FIGS. 8 and 18.

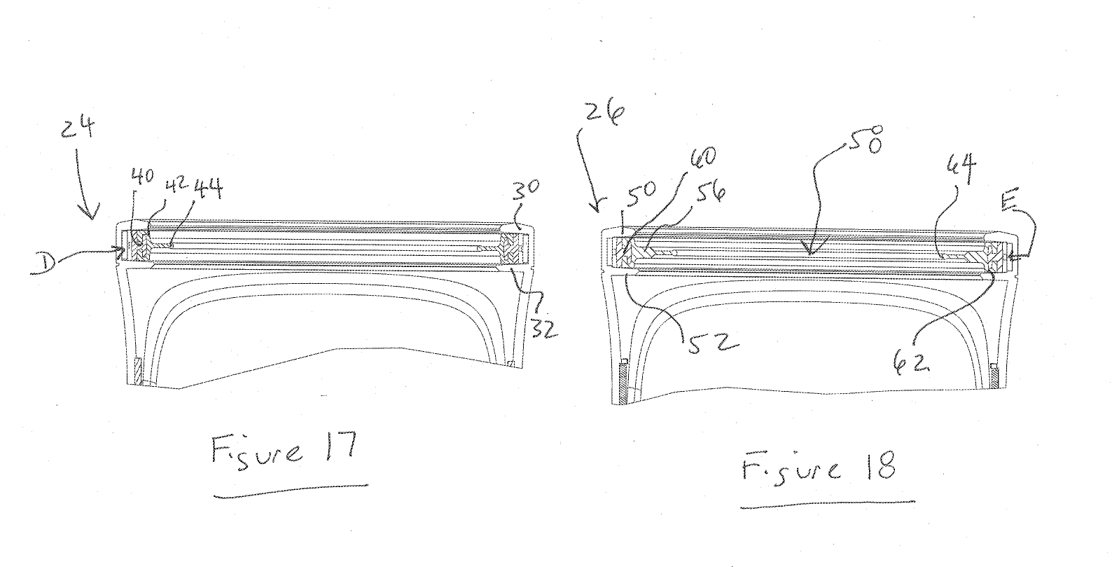

Referring to FIGS. 12 through 17, end 24 of dispenser A includes inwardly extending wall portions 30 and 32. Wall portion 30 forms the outer wall of housing 2 and is spaced from and extends substantially parallel to inner wall portion 32. Releasable cup retainer D includes a support frame member 34 and a flexible membrane 36 having a substantially central opening 38. Frame 34 seats between wall portions 30 and 32. Preferably, frame 34 is rigid or semi-rigid. Flexible membrane or gasket 36 is preferably detachably connected to frame 34. As seen in FIG. 16, frame 34 preferably includes a substantially T-shaped connecting member 40 and flexible member 36 has a substantially C-shaped connecting member 42 which attaches about and surrounds T-shaped connecting member 40. Preferably, flexible membrane 36 preferably includes an enlarged engaging portion 44 for engaging a lip 46 or other structure of a drinking cup as seen in FIG. 7. Pulling on the exposed cup in stack B distorts member 36 such that it moves outwardly thereby allowing a single drinking cup to be dispensed. Upon removal of the drinking cup from dispenser A, the flexible nature of membrane 36 causes membrane 36 to spring back or return to its original position prior to application of a removal force on the drinking cup. This causes engaging portion 44 to engage lip 46 of the next drinking cup in stack B to ensure that only a single drinking cup is dispensed from end 24 at a given time.

Referring to FIGS. 8 and 18, end 26 of dispenser A includes inwardly extending wall portions 50 and 52. Wall portion 50 is preferably identical to wall portion 30 and wall portion 52 is preferably identical to wall portion 32. Wall portion 50 forms the outer wall of housing 2 and is spaced from inner wall portion 52 the same distance that wall portion 30 is spaced from wall portion 32. Releasable cup retainer E includes a support frame member 54 that is identical to support frame member 34. Accordingly, either support frame member may be positioned at either end of dispenser A. Frame 54 seats between wall portions 50 and 52.

Releasable cup retainer E further includes a flexible membrane 56 having a substantially central opening 58. Flexible membrane 56 is preferably detachably connected to frame 54. As seen in FIG. 18, frame 54 preferably includes a substantially T-shaped connecting member 60 that is identical to T-shaped connecting member 40. Preferably, flexible member 56 has a substantially C-shaped connecting member 62 which is similar or identical to C-shaped connecting member 42. Accordingly, either flexible membrane can be used with either frame support member. Referring to FIGS. 17 and 18, flexible membrane 56 has a smaller central opening than flexible membrane 36 to allow flexible member 56 to releasably retain smaller drinking cups than membrane 36.

Flexible membrane 56 preferably includes an enlarged engaging portion 64 for engaging a lip 46 or other structure of a drinking cup. Pulling on the exposed cup in stack C distorts member 56 such that it moves outwardly thereby allowing a single drinking cup to be dispensed. Upon removal of the drinking cup from dispenser A, the flexible nature of membrane 56 causes membrane 56 to spring back or return to its original position prior to application of a removal force on the drinking cup. This causes engaging portion 64 to engage lip 46 of the next drinking cup in stack C to ensure that only a single drinking cup is dispensed from end 26 at a given time.

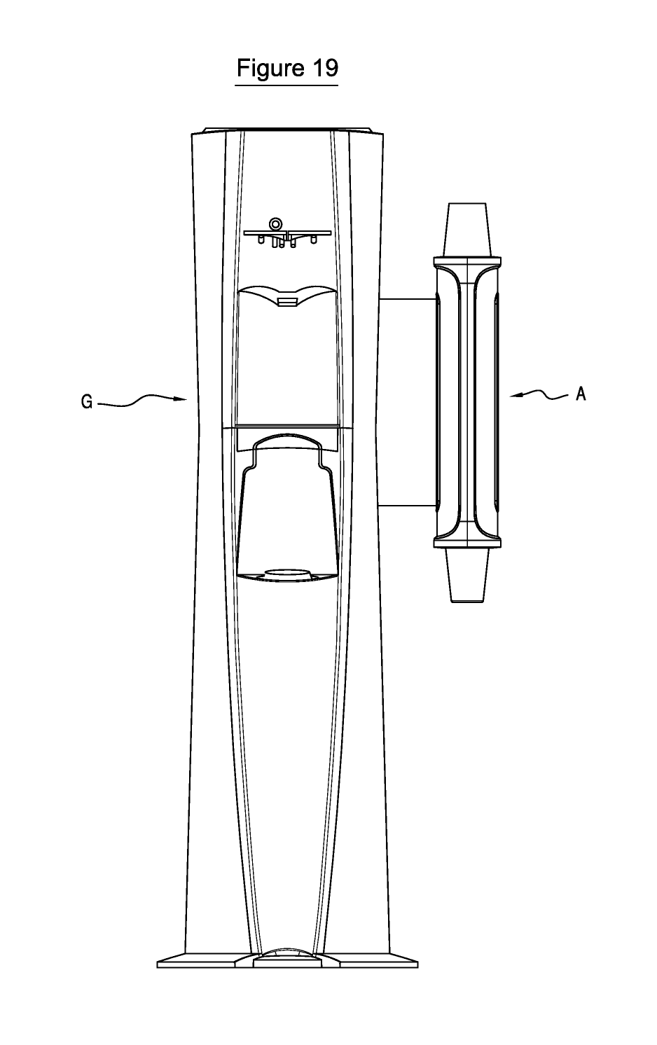

Referring to FIGS. 1 and 2, housing 2 may be provided with one or more mounting members 70 for facilitating mounting of dispenser A in a desired location. For example, as seen in FIG. 19, dispenser A may be mounted on dispenser G. Dispenser G can dispense any flowable material or liquid including but not limited to chilled water, hot water, soda, coffee, tea, etc. Preferably, dispenser G is a water cooler for dispensing water. The water cooler can be used with a bottom loaded five gallon water bottle, an inverted five gallon water bottle or a water cooler using bags or other non-bottle type water containers.

The preferred form of cup dispenser A is extremely versatile. First, it can simultaneously dispense two cups from two different dispensing areas of dispenser A. Also, the cups dispensed simultaneously from the two different dispensing areas can be of two different sizes (e.g., large cup and small cup). The preferred form of cup dispenser A can be mounted horizontally, vertically or in some other manner as dispenser A does not depend on gravity to aid cup dispensing. Referring to FIG. 3, dispenser A can be used to dispense two sets of stacked cups (as seen in FIG. 3) with larger cups dispensed from the top and smaller cups dispensed from the bottom. Where dispenser A has not yet been mounted, smaller cups can be dispensed from the top by simply rotating dispenser A 180 degrees from the orientation shown in FIG. 3. Where dispenser A has already been mounted on a liquid dispenser or another mounting surface, one need only switch the flexible membranes 36 and 56 to switch which ends dispense the larger and smaller drinking cups. Referring to FIGS. 4 and 5, dispenser A can be used to dispense a stack of drinking cups from only one end. FIG. 4 depicts an orientation in which the larger drinking cups are dispensed from the top while FIG. 5 shows dispenser A rotated 180 degrees from the orientation in FIG. 4 to dispense the smaller drinking cups from the top. It should be noted that cups seats 8 and 10 act with the corresponding flexible membrane to seal off the ends of the dispenser A when no cups are present at an end of dispenser A.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

We claim:

1. A cup dispenser for housing and dispensing a plurality of drinking cups, said cup dispenser including:
(a) a first stack of a plurality of drinking cups, a second stack of a plurality of drinking cups and a body simultaneously housing said first stack of a plurality of drinking cups and said second stack of a plurality of drinking cups, said body having a first end and a second end, said first end having a first opening through which drinking cups in said first stack of a plurality of drinking cups can be dispensed one after the other, said second end having a second opening through which drinking cups in said second stack of drinking cups can be dispensed one after the other; and,
(b) said body being configured such that a drinking cup from said first stack of a plurality of drinking cups can be dispensed at the same time a drinking cup in said second stack of a plurality of drinking cups is dispensed.

2. The cup dispenser of claim 1, further including:
(a) at least one biasing member extending between said first stack of a plurality of drinking cups and said second stack of a plurality of drinking cups, said at least one biasing member being configured to urge said first stack of a plurality of drinking cups in a first direction and urge said second stack of a plurality of drinking cups in a second direction, the second direction is different from the first direction.

3. The cup dispenser of claim 2, wherein:
(a) said at least one biasing member is a single spring.

4. The cup dispenser of claim 3, further including:
(a) a first cup seat and a second cup seat, said spring being disposed between said first cup seat and said second cup seat such that said spring urges said first cup seat in said first direction and said second cup seat in said second direction.

5. The cup dispenser of claim 4, further including:
(a) a first releaseable cup retainer for releaseably retaining drinking cups in said first stack of a plurality of drinking cups; and,
(b) a second releaseable cup retainer for releasably retaining drinking cups in said second stack of a plurality of drinking cups, said second releasable cup retainer being configured to releasably retain drinking cups of a size different from drinking cups releasably retained by said first releaseable cup retainer.

6. The cup dispenser of claim 5, wherein:
(a) said first releaseable cup retainer includes a first frame and a first flexible membrane, said first frame supports said first flexible membrane and said first flexible member includes an engaging member that engages a corresponding drinking cup in said first stack of drinking cups; and,
(b) said second releaseable cup retainer includes a second frame and a second flexible membrane, said second frame supports said second flexible membrane and said second flexible member engages a corresponding drinking cup in said second stack of drinking cups.

7. The cup dispenser of claim 6, wherein:
(a) said first cup seat includes a drinking cup support surface, a skirt and a first hollow cavity;
(b) said second cup seat includes a drinking cup support surface, a skirt and a second hollow cavity; and,
(c) said spring is a coil spring having first and second ends, said first end of said coil spring extends into said first hollow cavity and said second end of said coil spring extends into said second hollow cavity.

8. A double ended cup dispenser for simultaneously dispensing cups at each of two ends of the double ended cup dispenser, said double ended cup dispenser comprising:
(a) a housing having first and second ends, said first end of said housing having a first opening through which one or more cups can dispensed, said second end of said housing having a second opening through which one or more cups can be dispensed at substantially the same time cups are dispensed from said first end of said housing;
(b) a first cup support member being disposed in said housing for supporting one or more cups;
(c) a second cup support member being disposed in said housing for supporting one or more cups; and,
(d) at least one biasing member for biasing said first cup support member toward said first end of said housing and biasing said second cup support member toward said second end of said housing.

9. The double ended cup dispenser of claim 8, wherein:
(a) said first end of said housing is disposed below said second end of said housing.

10. The double ended cup dispenser of claim 9, further including:
(a) said at least one biasing member is a single coil spring.

11. The double ended cup dispenser of claim 10, wherein:
(a) said housing is substantially tubular and an axis passing through a center of said first opening passes through a center of said second opening.

12. The double ended cup dispenser of claim 11, wherein:
(a) said housing includes at least one mounting member for mounting the housing on or adjacent a liquid dispenser in at least two different orientations wherein in a first orientation the first end of the housing is positioned above the second end of the housing and in a second orientation the first end of the housing is positioned below the second end of the housing.

13. The double ended cup dispenser of claim 12, further including:
(a) a first stack of a plurality of cups disposed in said housing adjacent said first end of said housing; and,
(b) a second stack of a plurality of cups disposed in said housing adjacent said second end of said housing wherein an opening of each cup in said second stack of a plurality of cups faces an opening in each cup of said first stack of a plurality of cups.

14. The double ended cup dispenser of claim 13, further including:
(a) a first releaseable cup retainer at least a portion of which is detachably connected to said housing, said first releaseable cup retainer being configured to releaseably retain cups in said first stack of a plurality of cups; and,
(b) a second releaseable cup retainer at least a portion of which is detachably connected to said housing, said second releaseable cup retainer being configured to releaseably retain cups in said second stack of a plurality of cups.

15. The double ended cup dispenser of claim 14, wherein:
(a) said first releaseable cup retainer includes a first frame and a first flexible membrane, said first frame supports said first flexible membrane and said first flexible member includes an engaging member that engages a corresponding drinking cup in said first stack of drinking cups; and,
(b) said second releaseable cup retainer includes a second frame and a second flexible membrane, said second frame supports said second flexible membrane and said second flexible member engages a corresponding drinking cup in said second stack of drinking cups wherein said first frame and said second frame are identical.

16. The double ended cup dispenser of claim 15, wherein:
(a) said first flexible membrane is sized to engage a first sized cup and said second flexible member is sized to engage a cup larger than said first sized cup.

17. The double ended cup dispenser of claim 16, wherein:
(a) said first flexible membrane is configured such that said first flexible member can be detachably connected to either said first frame or said second frame; and,
(b) said second flexible membrane is configured such that said second flexible member can be detachably connected to either said first frame or said second frame.

18. A liquid dispensing apparatus, said liquid dispensing apparatus including:
(a) a liquid dispenser for dispensing one or more liquids; and,
(b) a double ended cup dispenser for simultaneously dispensing cups at each of two ends on said double ended cup dispenser.

19. The liquid dispensing apparatus of claim 18, wherein:
(a) said liquid dispenser includes a housing and said double ended cup dispenser is connected to said housing.

20. The liquid dispensing apparatus of claim 19, wherein:
(a) said double ended cup dispenser includes a substantially tubular housing having first and second ends, a first stack of a plurality of drinking cups housed in said substantially tubular housing, a second stack of a plurality of drinking cups housed in said substantially tubular housing and at least one biasing element biasing said first stack of a plurality of drinking cups towards said first end of said substantially tubular housing and biasing said second stack of a plurality of drinking cups toward said second end of said substantially tubular housing.
